(19) United States
(12) Patent Application Publication
(10) Pub. No.: US 2014/0236541 A1
(43) Pub. Date: Aug. 21, 2014

(54) VIRTUAL REALITY DESIGN APPARATUS AND METHOD THEREOF

(71) Applicant: Hyoung Seob LEE, Daegu (KR)

(72) Inventor: Hyoung Seob LEE, Daegu (KR)

(21) Appl. No.: 14/022,429

(22) Filed: Sep. 10, 2013

(30) Foreign Application Priority Data
Feb. 15, 2013 (KR) 10-2013-0016117

(51) Int. Cl. G06F 17/50

(52) U.S. Cl. CPC G06F 17/5004
USPC 703/1

(57) ABSTRACT

Provided is a virtual reality design apparatus and a method thereof, which previously design a construction environment the same as reality before the construction by photographing a construction material and applying the image of the construction material to a design space. The virtual reality design device includes a construction image acquiring unit to acquire an image of a design space, and acquire an image of a real construction material, or an existing construction environment, an input unit to input mapping information to the image, and input a function to realize a virtual reality design, a control unit to control storage of the image, and control execution of a design application according to the functions, and a design application executing unit to execute the stored design application and create a design identical to reality under a control of the control unit.

### BACKGROUND OF THE INVENTION

1. Field of the Invention

The present invention relates to a virtual reality design. More particular, the present invention relates to a virtual reality design apparatus and a method thereof, capable of previously designing a construction environment the same as reality before the construction by photographing a real construction material and applying the image of the real construction material to a design space.

In this case, the design space refers to a virtual construction space the same as a real construction space in which a construction work is performed by using a construction material (finishing material).

2. Description of the Related Art

In general, a construction design work or an interior design work is performed by previously and virtually applying various construction materials to a construction space before the construction design work or the interior design work is performed. If a user selects the construction material after checking the design state, a constructor applies the construction materials selected by the user to a real construction space.

Following technologies according to the related art are disclosed in order to simulate a construction design work or an interior design work by applying construction materials to a construction space in a virtual state before the construction design work or the interior design work is actually performed.

Japanese Unexamined Patent Publication No. 2006-318358 (published on Nov. 24, 2006) discloses a technology of totally supporting a user through the browsing, selecting, and analyzing of an object, or movement preparation, of suggesting an ideal interior environment, of stabilizing the mind and the body of the user, and of reducing the time to implement an interior environment.

In addition, Japanese Unexamined Patent Publication No. 2002-245096 (published on Aug. 30, 2002) discloses a technology of simply simulating the layout in an interior design through a general-purpose computer.

In addition, Korean Unexamined Patent Publication No. 10-2010-0005517 (published on Jan. 15, 2010) discloses a technology of allowing a worker to select a space through one drawing work and modeling finishing materials, which are used in the selected space based on object attributes and drawing rules thereof, to reduce a modeling work amount and a modeling work time in relation to 3-D modeling works of the finishing materials.

Further, Korean Unexamined Patent Publication No. 10-2001-0110568 (published on Nov. 13, 2001) discloses a technology of performing an interior design work according to a user preference over the Internet network based on 3D worked database on real drawings according to addresses.

In addition, Korean Patent Registration No. 10-0735676 (issued on Jul. 6, 2007) discloses a system and a method of operating a virtual reality model house capable of maximizing the immersion into the virtual reality and the sense of reality by acquiring and simulating additional information.

Further, Korean Unexamined Patent Publication No. 10-2011-0087028 (published on Aug. 2, 2011) discloses a technology of allowing a user to personally select and edit an interior design space and to arrange props so that the user previously expresses and experience the optimal 3D design space while calculating the estimation for the optimal interior design in real time.

However, according to the related arts, since real construction materials are not used, even if a structure or an interior design is simulated before the structure is constructed, the sense of reality may be degraded.

Therefore, according to the related art, when a structure is constructed (finishing materials are applied), a great amount of time is spent until a customer selects the tiles of a restroom or finishing materials of a room wall or a floor.

Therefore, according to the related arts, even though simulations are performed, the sense of reality is degraded. In addition, even though the construction is performed by using the finishing materials selected by the customer, the finishing materials may be frequently changed.

### DOCUMENT OF RELATED ART

### Patent Document

(Patent Document 1)

Japanese Unexamined Patent Publication No. 2006-318358 (published on Nov. 24, 2006).

(Patent Document 2)

Japanese Unexamined Patent Publication No. 2002-245096 (published on Aug. 30, 2002).

(Patent Document 3)

Korean Unexamined Patent Publication No. 10-2010-0005517 (published on Jan. 15, 2010).

(Patent Document 4)

Korean Unexamined Patent Publication No. 10-2001-0110568 (published on Nov. 13, 2001).

(Patent Document 5)

Korean Patent Registration No. 10-0735676 (issued on Jul. 6, 2007).

(Patent Document 6)

Korean Unexamined Patent Publication No. 10-2011-0087028 (published on Aug. 2, 2011).

### SUMMARY OF THE INVENTION

The present invention has been made keeping in mind the above problems occurring in the prior art, and an object of the present invention a virtual reality design apparatus and a method thereof, capable of previously designing a construction environment the same as reality before the construction by photographing a real construction material and applying the image of the real construction material to a design space.

Another object of the present invention is to provide a virtual reality design apparatus and a method thereof, capable of allowing a customer to reduce time to decide finishing materials and reducing time and cost waste caused by changing finishing materials after applying the finishing materials.

Still another object of the present invention is to provide a virtual reality design apparatus and a method thereof, capable of applying real construction materials to a design space and adjusting internal brightness so that a finished design is matched with a real interior environment, thereby realizing the senses of realism and reality.

In order to accomplish the above object, there is provided an apparatus for designing an interior construction space including an interior floor and an interior wall surface by using a construction material including a floor material, wallpaper or a tile through virtual reality. The apparatus includes a construction image acquiring unit to acquire an image of a design space comprising an interior floor and an interior wall surface, and acquire a real construction material comprising a flooring material, a wallpaper, and a tile, or an existing construction environment in a form of an image, an input unit to input mapping information to the image acquired by the construction image acquiring unit, and input a function to realize a virtual reality design, a control unit to control storage of the image acquired by the construction image acquiring unit, and control execution of a design application according to the functions input through the input unit, a design application executing unit to execute the stored design application and create a design identical to reality by applying a construction image, which is obtained by photographing a real construction, to the acquired design space, under a control of the control unit, a storage unit to store the design application, a display unit to display a construction design implemented by the design application executing unit onto a screen image, a design information generating unit to generate design transmission information used to transmit a full screen image or a preview screen image generated by the design application executing unit through communication, and a communication unit to transmit the design transmission information generated by the design information generating unit to a remote place through a communication network.

In addition, the design application executing unit includes an application executing module to execute the stored design application under the control of the control unit, a design space extracting module to extract a design space to be designed, a construction material application module to apply the real construction materials to the design space for a designing work, and a strip generating module to generate a strip when the tile is required in the design space and apply the strip to the design space. If the construction material is a construction material supplied by a construction material company, information of the construction material is supplied together with the construction material for variety in company selection and material selection.

In addition, the design application executing unit further includes a full screen image generating module to generate the full screen image to display the design space created by the construction material application module onto a screen, and a preview screen image generating module to generate the preview screen image by scanning the full screen image generated by the full screen image generating module through an image scan function.

In addition, the design application executing unit further comprises a brightness adjusting module to adjust brightness of the design space created by the full screen image generating module such that a construction environment is expressed corresponding to a real interior environment state according to brightness manipulation by a user.

Further, there is provided a method of designing an interior construction space including an interior floor and an interior wall surface by using a construction material including a floor material, wallpaper or a tile through virtual reality. The method includes (a) storing a design application to design the interior construction space in a storage unit, (b) acquiring and storing an image of a design space comprising a floor and a wall surface at an interior to be designed, areal construction material, or a real construction environment, (c) executing the design application according to an application execution command of a user, (d) extracting the design space comprising the floor and the wall surface at the interior to be designed, and extracting a construction material to be applied to the design space to apply the construction material to the design space, and (e) generating and storing a full screen image and a preview screen image of the design space to which the construction material is applied.

Further, the method further includes (f) expressing a construction environment corresponding to a real interior environment state of the interior by adjusting brightness of the full screen image if the user requests application of an interior environment state to the construction environment.

In addition, the method further includes (g) generating the full screen image or the preview screen image stored in step (e) in a form of transmission information if image transmission is requested by the user and transmitting the transmission information to a communication network.

As described above, according to the present invention, since an environment the same as reality can be previously designed before a construction work is performed by photographing a real construction material and applying the image of the real construction materials to a design space.

In addition, according to the present invention, the design of a construction environment the same as reality is possible, thereby preventing the time and cost waste caused by frequently changing finishing materials after the finishing materials have been applied.

In addition, according to the present invention, real construction materials can be applied to a design space and internal brightness can be adjusted so that a finished design is matched with a real interior environment, thereby realizing the senses of realism and reality.

Further, according to the present invention, when real construction materials are applied to the design space, the information of a construction material company (the name of the construction material company, the phone number of the company, the information of a material price, and others) is provided together with the construction materials, so that an individual and a company can create added values together.

### BRIEF DESCRIPTION OF THE DRAWINGS

FIG. 1 is a block diagram showing the structure of a virtual reality design apparatus according to the present invention.

FIG. 2 is a block diagram showing the structure of a design application executing unit of FIG. 1 according to the embodiment of the present invention.

FIG. 3a is a view showing an example that a construction material (stone material) is applied to a living room of the design space according to the present invention.

FIG. 3b is a view showing an example that a construction material (wall paper) is applied to a room of the design space according to the present invention.

FIG. 3c is a view showing an example that a construction material (tile) is applied to a rest room of the design space according to the present invention.

FIGS. 4a and 4b are views showing photographs of real construction and interior design materials to be applied to the present invention.

FIG. 5 is a flowchart showing a virtual reality design method according to the present invention.

### DETAILED DESCRIPTION OF THE INVENTION

Hereinafter, exemplary embodiments of the present invention will be described with reference to accompanying drawings. Prior to the description of the present invention, the details of the generally known function and structure, which make the subject matter of the embodiment unclear, will be omitted.

### Embodiment 1

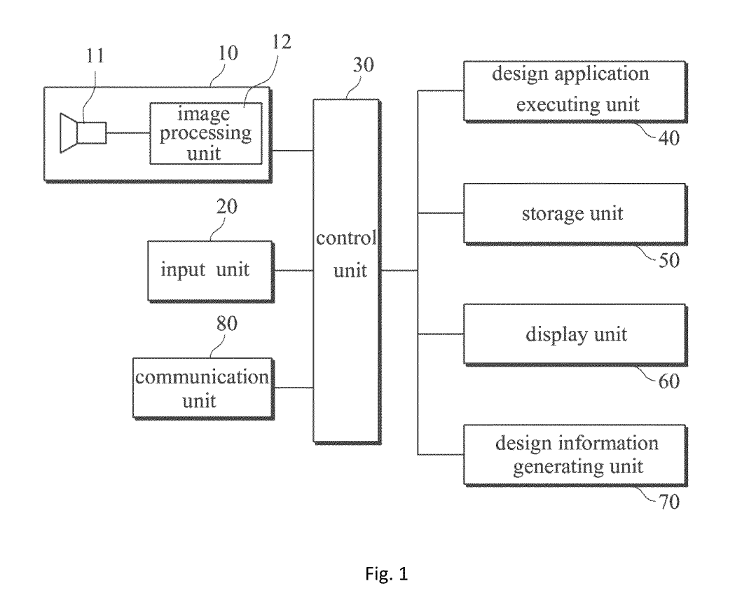

FIG. 1 is a block diagram showing the structure of a virtual reality design apparatus according to the present invention. The virtual reality design apparatus includes a construction image acquiring unit 10, an input unit 20, a control unit 30, a design application executing unit 40, a storage unit 50, a display unit 60, a design information generating unit 70, and a communication unit 80.

Preferably, the virtual reality design apparatus is implemented in a cellular phone, such as a smart phone, a tablet PC, a laptop computer, and a personal digital assistant (PDA), actually handheld by a user.

In this case, the virtual reality refers to that a user arbitrarily makes a specific environment or a specific situation in a device to feel as if the user interacts with a real interior environment. According to the present invention, the virtual reality refers to that a user feels as if a construction environment, which is completed by applying construction materials to a design space in a cellular phone, is the same as a real environment.

The construction image acquiring unit 10 acquires the image of the design space, and acquires real construction materials such as flooring materials, wallpaper, or tiles, or an existing construction environment (that is, the wall surface or the bottom surface of the interior subject to the construction of the wallpaper or the tile) as images. Preferably, the construction image acquiring unit 10 includes a camera 11 to photograph the design space, the real construction materials or the existing construction environment and an image processing unit 12 to process the image photographed by the camera 11.

The input unit 20 inputs mapping information to the image acquired by the construction image acquiring unit 10, and inputs functions to realize virtual reality designs. In this case, the mapping information refers to information such restrooms, rooms, living rooms, and ceilings. Preferably, the input unit 20 is implemented by using a device such as a keypad to input the mapping information.

The control unit 30 controls the storage of the image acquired by the construction image acquiring unit 10, and controls the execution of a design application according to the functions input through the input unit 20. The control unit 30 is preferably implemented by using a control device such as a micro-processor, a central process unit, a micom, and a controller.

The design application executing unit 40 executes the stored design application and creates a design identical to reality by applying the construction image, which is obtained by photographing a real construction to the design space, under the control of the control unit 30.

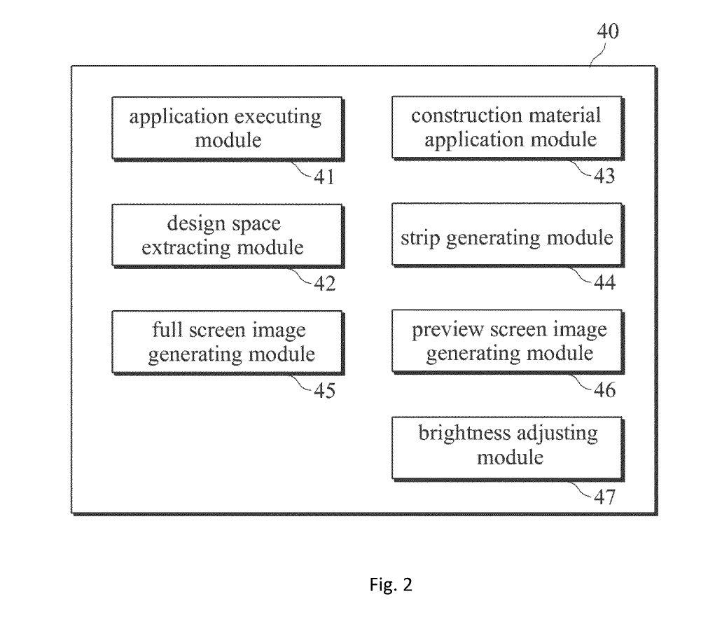

As shown in FIG. 2, the design application executing unit 40 includes an application executing module 41 to execute the stored design application under the control of the control unit 30, a design space extracting module 42 to extract a design space to be designed, a construction material application module 43 to apply the real construction materials to the design space for a designing work, and a strip generating module 44 to generate a strip if tiles are required in the design space and apply the strip to the design space.

In addition, the design application executing unit 40 further preferably includes a full screen image generating module 45 to generate a full screen image to display the design space created by the construction material application module 43 onto a screen, a preview screen image generating module 46 to generate a preview screen image by scanning the full screen image generated by the full screen image generating module 45 through an image scan function, and a brightness adjusting module 47 to adjust the brightness of the design space created by the full screen image generating module 45 such that a construction environment is made corresponding to a real interior environment state according to the brightness manipulation by a user.

The storage unit 50 stores the design application. The storage unit 50 stores information of the acquired design space, the real construction materials, and the construction environment. The storage unit 50 may be implemented by using a hard disc or a memory.

The display unit 60 displays a construction design implemented by the design application executing unit 40 onto the screen image. The display unit 50 is implemented by using a display device such as a liquid crystal display or a touch screen. In addition, the display unit 60 is preferably implemented by using a touch screen to allow a user to smoothly input information.

The design information generating unit 70 generates design transmission information used to transmit the full screen image or the preview screen image generated by the design application executing unit 40 through communication. In other words, the design information generating unit 70 generates the design transmission information in the form of a file or a text message.

The communication unit 80 transmits the design transmission information generated by the design information generating unit 70 to a remote place through a communication network. The user may conveniently transmit the design created on the terminal of the user to builders, constructors, or acquaintances through the communication unit 80. The communication unit 80 refers to a wired or wireless communication appliance, which is generally known to those skilled in the art, allowing the transceiving of information.

Hereinafter, the operation of the virtual reality design apparatus having the above structure according to the present invention will be described in detail.

A user attempting to design a design space in an interior of a building by using a finishing material such as wallpaper, a floor material, or a tile photographs the space of the interior, to which the finishing material is not applied, by using the present virtual reality design apparatus and stores the image of the space. In addition, the user photographs a real construction material such as a wall paper, a floor material, or a tile, or an existing constructed environment and stores the image of the real construction material by using the present virtual reality design apparatus. In this case, the present virtual reality design apparatus refers to a user terminal such as a smart phone, a PDA, a laptop computer, or a tablet PC (iPAD) installed therein with the design application.

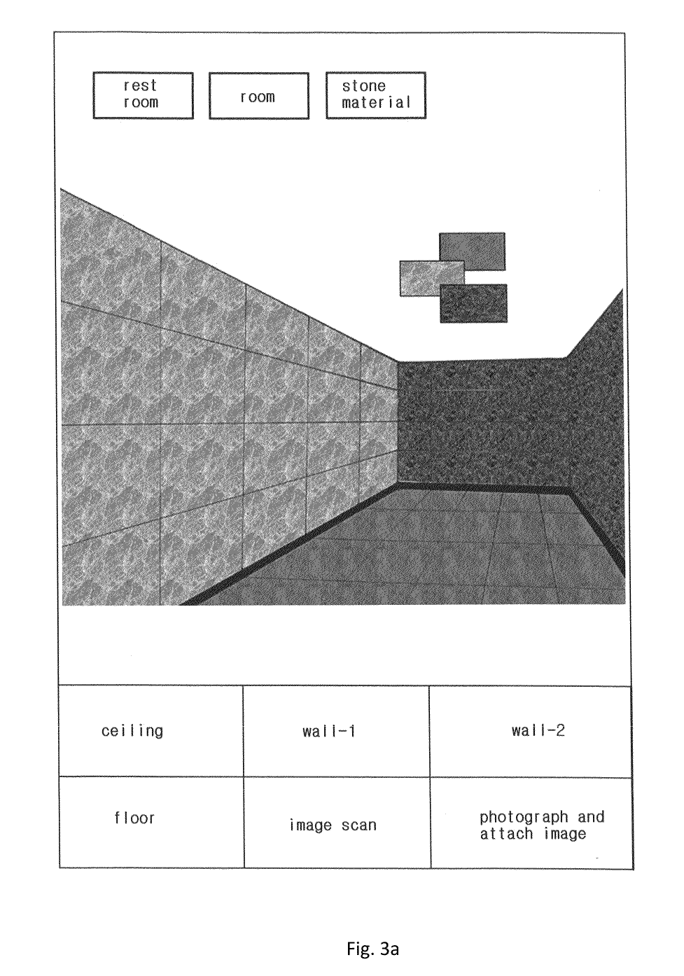

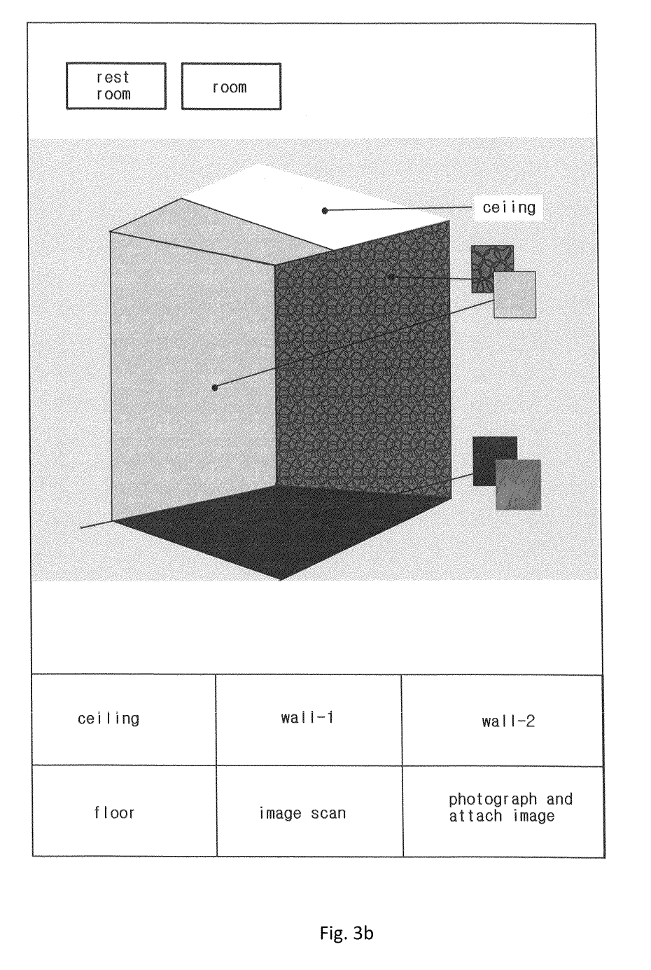

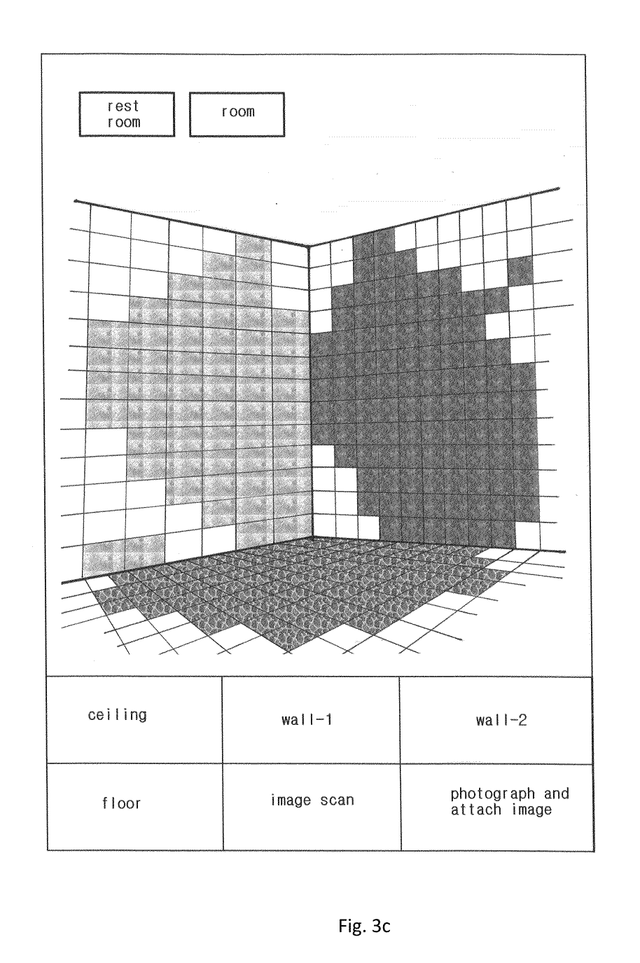

In other words, a user photographs a design space (a space to which finishing materials are actually applied, a room, a living room, a rest room, and a porch) through the camera 11 of the construction image acquiring unit 10. The photographed design space is processed by the image processing unit 12 and transmitted to the control unit 30. The control unit 30 stores the mapping information input through the input unit 20 and the image processed by the image processing unit 12 in the storage unit 50 through the mapping between the mapping information input through the input unit 20 and the image processed by the image processing unit 12. In this case, the mapping information may include design space information representing the design space and attribute information representing the attributes of the design space. The design space information refers to the interior information of a real building such as a room, a living room, a rest room, and a porch. FIG. 3 shows one example of the design space. The image of the design space may be allocated with the attribute information of a ceiling, a floor, a first wall member, or a second wall member related to the design space.

If the user photographs a specific space by using the camera 11 and inputs mapping information which is represented as “first design space”, or “room”, through the input unit 20, the control unit 30 maps “first design space” or “room” onto the image information acquired through the camera 11 and stores the image information having the mapping information in the storage unit 50.

The user, which has stored the image information for the design space, photographs real construction materials or the existing construction environment while going around. Generally, the construction materials used to design a building through an existing computer or an existing network are imaged construction materials instead of real construction materials. Accordingly, when the design is simulated by using the imaged construction materials, the imaged construction materials may be mostly different from the real construction materials, so that various problems may be caused.

According to the present invention, in order to solve the above problems and enhance the senses of realism and reality, the user personally photographs the real construction materials and utilizes the construction materials when personally designing the existing construction environment after photographing the construction environment.

For example, if the user photographs the real construction materials through the camera 11, and inputs the mapping information through the input unit 20, the control unit 30 combines the mapping information with the photographed image and stores the photographed image combined with the mapping information in the storage unit 50 as the information of the construction materials. In other words, if the user personally photographs tiles actually used in a restroom and inputs information of “rest room tile”, or “rest room wall” as the mapping information, the control unit 30 combines the information of “rest room tile” with the photographed rest room tile image and stores the rest room tile image combined with the information of “rest room tile” in the storage unit 50.

According to another embodiment, the virtual reality design apparatus may store construction material information (the name of a construction company, the phone number of the construction company, and the price information of the construction materials) supplied from existing suppliers of construction materials in the storage unit 50 in connection with the construction materials.

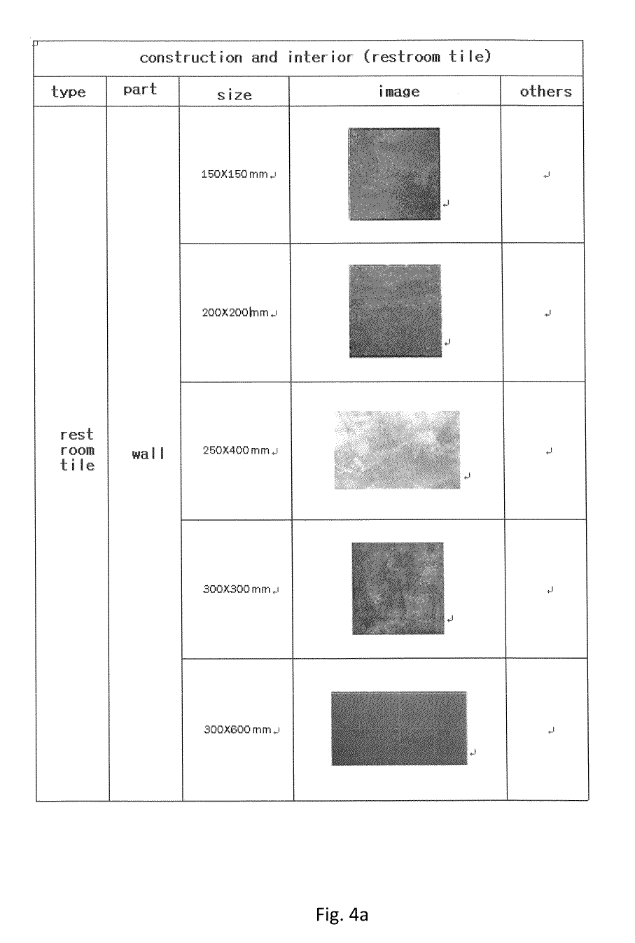

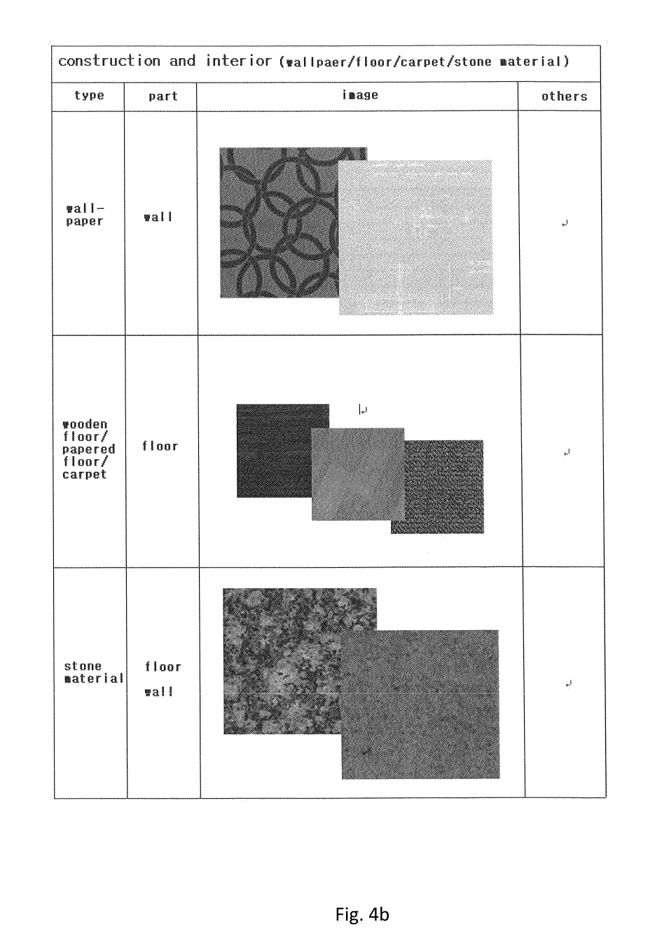

FIG. 4a shows images for the real construction materials acquired by photographing real rest room tiles, in which mapping information attributes that a type is “rest room tile”, and a part is “wall” are combined with the images.

FIG. 4b shows images for the real construction materials acquired by individually photographing wallpaper, a floor, and a stone material, which are the real construction materials, or photographing wallpaper, a floor, and a stone material in an existing construction.

The user acquires construction materials attracted by the user as images while going around through the above procedure.

Thereafter, the user implements a design space to be actually designed by the user by applying the acquired real construction materials to the design space.

Regarding the design implementation, if a command to execute a design application is input through the input unit 20, the control unit 30 recognizes the command to operate the design application executing unit 40.

If the command is sent by the control unit 30, the design application executing unit 40 extracts and executes the design application stored in the storage unit 50 through the application executing module 41. In this case, the design application is regarded as being downloaded through the communication unit 80 and stored in the storage unit 50 before the images of the design space or the construction materials are acquired. In addition to the above scheme, a memory device such as a USB may be connected to download the design application.

In the state that the design application is executed, a user selects a design space to be designed among various design spaces previously stored through the input unit 20 and stored in the storage unit 50. In this case, the user may select the information of the construction materials provided from a conventional construction company. If the design space is selected, the design space extracting module 42 of the design application executing unit 40 operates under the control of the control unit 30 to extract the design space selected by the user from among the design spaces stored in the storage unit 50 and display the design space on the display unit 60.

In the state that the design space to be designed is displayed onto the display unit 60, the user selects the position to be designed, and selects the images of the construction materials such as wallpaper, floor materials, and tiles stored in the storage unit 50 and applied to the space through the input unit 20. The above description is made in that the selection of the positions or the construction materials are performed through the input unit 20. However, if the display unit 60 is realized by using a touch screen, the selection of the position or the construction materials is possible through only a touch operation for the related position.

If a space to be designed is selected by the user, and the images of the construction materials are selected, the construction material application module 43 of the design application executing unit 40 operate under the control of the control unit 30 to extract the images of the construction materials stored in the storage unit 50 and apply the images to the related position of the design space selected by the user. In addition, the selected design space is overlaid with the extracted images of the construction materials, so that the construction environment significantly similar to the real construction environment is realized. In addition, the application of the construction materials to the related design space is terminated through the input unit 20 or by manipulating select keys such as “Confirm” or “Settings” displayed on a screen image. If the construction materials provided from the construction company are selected, the information of the construction materials cooperating with the construction materials is displayed together with the construction materials. Accordingly, the user may simultaneously obtain the information of the construction materials when selecting the specific construction materials. In this case, preferably, when the information of the construction materials is provided, if there are several companies to supply the same construction materials, the information of all related companies must be provided, so that the user may compare prices of the construction materials. In addition, preferably, the user must be able to make communication with a related company in real time or make connection with the related company through the communication unit 80, so that the user may order attracted construction materials in real time or make real-time construction contact with the related company in relation to the construction of the attracted construction materials.

If the images of the construction materials are large or small, the construction material application module 43 preferably applies the construction materials to a related design space by adjusting the sizes of the images of the construction materials suitably for the design space.

Meanwhile, if the design space is a rest room, a strip is made between tiles. Accordingly, if the user selects the strip through the input unit 20, the strip generating module 44 generates the strip and applies the strip to the design space. Regarding the generation of the strip, it is preferred that various strips are previously stored in the storage unit 50 and extracted from the storage unit 50 for the use of the strip.

Through the above procedure, if the design space is a room, construction materials (e.g., wallpaper) are applied to a ceiling, construction materials (e.g., papered floor) are applied to a floor surface, or construction materials (e.g., wallpaper) are applied to three sides or four sides, thereby implementing virtual reality.

The design implemented through the above method may have the same environment substantially identical to a real construction site because real construction materials and real design spaces are applied to the design. Accordingly, it is unnecessary to personally construct several construction materials to a space to be constructed in a construction work. In addition, it is unnecessary to spend a great amount of time in order to select the construction materials.

In addition, according to another embodiment of the present invention, real interior environment information such as illuminance, brightness, or lighting may be applied to a construction environment implemented as described above. For example, the construction environment, such as illuminance or lighting, applied to a real building may be variously represented depending on the interior environment states.

Therefore, according to the present invention, a user may arbitrarily adjust the brightness by taking into consideration the above environment to determine how a construction environment designed by the user is expressed according to a real interior environment. For example, if a brightness adjustment command is input through the input unit 20, brightness is adjusted at the construction environment, in which the brightness adjusting module 47 of the design application executing unit 40 is implemented, according to the control of the control unit 30. Accordingly, since the construction environment displayed on the display unit 60 is affected identically to the case that the real interior environment state is affected, the colors of the construction environment may be weakened or cleared identically to those of the real interior environment. Brightness adjustment data may be easily applied by applying average illuminance according to environments such as morning, midday, evening, and night, and seasons and average illuminance based on lighting introduced into a lighting window. In particular, the brightness may be varied by adjusting light reflectance of wallpaper or tiles so that the colors of the construction environment may be weakened or cleared.

In other words, for example, a well-lighted interior is distinguished from an ill-lighted interior, so that wallpaper, floor materials, or tiles may be selected according to the lighting degree by taking lighting into consideration.

Therefore, finally, after the design of the design space has been finished, the full screen image is generated through the full screen image generating module 45 and stored in the storage unit 50. In addition, if necessary, the user may command the generation of the preview screen image, and the preview screen image generating module 46 generates a preview screen image of the full screen image through an image scan function according to the command and store the preview screen image in the storage unit 50. In the case of the preview screen image, if an appropriate screen image is clicked, the full screen image is displayed or a detailed screen image is displayed.

In addition, according to still another embodiment of the present invention, the full screen image or the preview screen image stored in the storage unit 50 as described above may be transmitted to a terminal of a builder or a constructor or a terminal of an acquaintance in the form of an e-mail or the form of a text message.

For example, if the user selects a transmission target through the input unit 20 and requests the image transmission, the design information generating unit 70 operates under the control of the control unit 30 to extract the selected image from the storage unit 50. In addition, if the user selects the transmission through e-mail, the user makes the extracted image in the form of a file and attaches the file to the e-mail. Alternatively, if the user selects text transmission, the user makes the extracted image in the form of a text message (an SMS message, or a multi-media message) and transmits the extracted image to the communication unit 80. The communication unit 80 transmits the transmitted information to the terminal of the builder or the constructor or the terminal of the acquaintance through a related wired network or a wireless network.

Accordingly, the user can conveniently transmit the information of the design implemented by the user to the builder or the constructor after the user personally checks and selects the information of the design. The builder or the constructor, which has received the information of the design, replies information of the construction possibility of the design implemented by the user and the construction cost in construction. Accordingly, the user can simply recognize the construction cost, and the construction can be rapidly performed by using the construction materials selected by the user.

### Embodiment 2

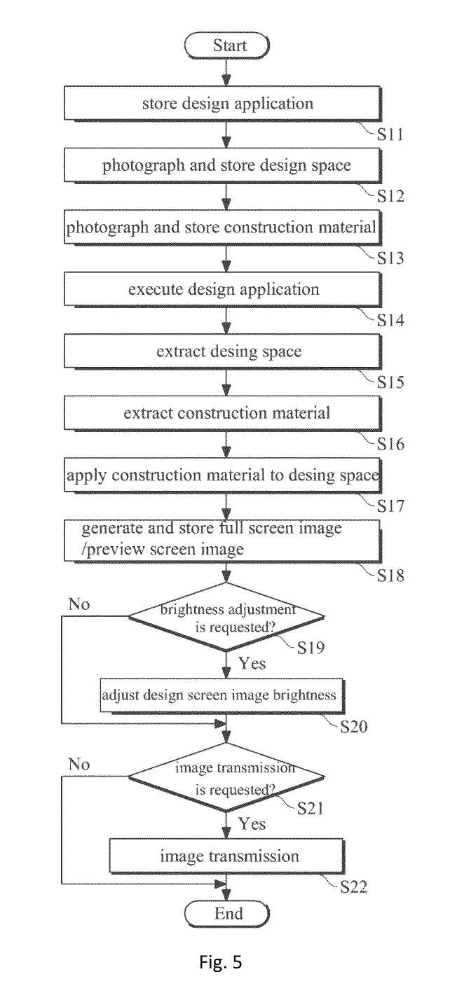

FIG. 5 is a flowchart showing a method of designing virtual reality according to the present invention.

As shown in FIG. 5, the method of designing the virtual reality according to the present invention includes (a) storing a design application to design a space to be constructed in a storage unit (step S11); (b) acquiring and storing an image of a design space to be designed, a real construction material, or a real construction environment (step S12 to S13); (c) executing the design application according to an application execution command of a user (step S14); (d) extracting the design space to be designed, and extracting construction materials to be applied to the design space to apply the construction materials to the design space (step S15 to S17); (e) generating and storing a full screen image and a preview screen image of the design space to which the construction materials are applied (step S18); (f) expressing a construction environment corresponding to a real interior environment state by adjusting brightness of the full screen image if application of the interior environment state to the construction environment is requested by the user (steps S19 to S20); and (g) generating the full screen image or the preview screen image stored in step (e) in the form of transmission information if image transmission is requested by the user and transmitting the transmission information to a communication network (steps S21 to S22).

The method of designing the virtual reality is performed through the cooperation between the control unit 40 and the design application executing unit 40 of FIG. 1.

The method of designing the virtual reality according to the present invention performed as described above includes storing a design application in the storage unit 50 in step S11. The design application is downloaded through the communication unit 80 and stored, or input and stored through a memory device such as an USB.

In steps S12 and S13, the control unit 30 acquires images of the design space, the real construction materials, and the existing constructed environment through the construction image acquiring unit 10 according to the manipulation of the user and stores the images in the storage unit 50.

Thereafter, if the user inputs the design application execution command, the design application stored in cooperation with the design application executing unit 40 is executed in step S14.

Thereafter, the design space, which is a design target stored in the storage unit 50, is extracted in step S15, and the real construction materials are extracted to be applied to the design space in step S16. In addition, the construction materials are combined with the designs space through an overlay scheme in step S17 so that the construction materials are applied to the design space.

Thereafter, the full screen image or the preview screen image of the construction environment having a complicated design is generated and stored in step S18.

Next, if the user requests the adjustment of the brightness in step S19, the process moves to step S20 so that the brightness of the full screen image or the preview screen image is adjusted to express the real construction environment to which the real interior environment state is applied. The whole color of the construction environment is weakened or cleared according to the brightness state.

If the user requests that the construction image personally implemented by the user is transmitted to a builder, a constructor, or an acquaintance, the full screen image or the preview screen image stored in the storage unit 50 is made in the form of a file or a text message and transmitted through an e-mail or a text message in steps S21 and S22.

As described above, according to the present invention, since the user can personally implement a construction environment the same as a real environment, the user can reduce the time to select the construction materials when applying the finishing materials in construction. In addition, it is unnecessary to re-apply the finishing materials when the user does not like the construction environment after the finishing materials have been applied.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for designing an interior construction space including an interior floor and an interior wall surface by using a construction material including a floor material, a wallpaper or a tile through virtual reality, the apparatus comprising:
a construction image acquiring unit to acquire an image of a design space comprising an interior floor and an interior wall surface, and acquire a real construction material comprising a flooring material, a wallpaper, and a tile, or an existing construction environment in a form of an image;
an input unit to input mapping information to the image acquired by the construction image acquiring unit, and input a function to realize a virtual reality design;
a control unit to control storage of the image acquired by the construction image acquiring unit, and control execution of a design application according to the functions input through the input unit;
a design application executing unit to execute the stored design application and create a design identical to reality by applying a construction image, which is obtained by photographing a real construction, to the acquired design space, under a control of the control unit;
a storage unit to store the design application;
a display unit to display a construction design implemented by the design application executing unit onto a screen image;
a design information generating unit to generate design transmission information used to transmit a full screen image or a preview screen image generated by the design application executing unit through communication; and
a communication unit to transmit the design transmission information generated by the design information generating unit to a remote place through a communication network.

2. The apparatus of claim 1, wherein the design application executing unit comprises:
an application executing module to execute the stored design application under the control of the control unit;
a design space extracting module to extract a design space to be designed;
a construction material application module to apply the real construction materials to the design space for a designing work; and
a strip generating module to generate a strip when the tile is required in the design space and apply the strip to the design space, and
wherein, if the construction material is a construction material supplied by a construction material company, information of the construction material is supplied together with the construction material for variety in company selection and material selection.

3. The apparatus of claim 2, wherein the design application executing unit further comprises:
a full screen image generating module to generate the full screen image to display the design space created by the construction material application module onto a screen; and
a preview screen image generating module to generate the preview screen image by scanning the full screen image generated by the full screen image generating module through an image scan function.

4. The apparatus of claim 3, wherein the design application executing unit further comprises a brightness adjusting module to adjust brightness of the design space created by the full screen image generating module such that a construction environment is expressed corresponding to a real interior environment state according to brightness manipulation by a user.

5. A method of designing an interior construction space including an interior floor and an interior wall surface by using a construction material including a floor material, a wallpaper or a tile through virtual reality, the method comprising:
(a) storing a design application to design the interior construction space in a storage unit;
(b) acquiring and storing an image of a design space comprising a floor and a wall surface at an interior to be designed, a real construction material, or a real construction environment;
(c) executing the design application according to an application execution command of a user;
(d) extracting the design space comprising the floor and the wall surface at the interior to be designed, and extracting a construction material to be applied to the design space to apply the construction material to the design space; and
(e) generating and storing a full screen image and a preview screen image of the design space to which the construction material is applied.

6. The method of claim 5, further comprising:
(f) expressing a construction environment corresponding to a real interior environment state of the interior by adjusting brightness of the full screen image if application of an interior environment state to the construction environment is requested by the user.

7. The method of claim 6, further comprising:
(g) generating the full screen image or the preview screen image stored in step (e) in a form of transmission information if image transmission is requested by the user and transmitting the transmission information to a communication network.
